(19) United States
(12) Patent Application Publication
(10) Pub. No.: US 2014/0292267 A1
(43) Pub. Date: Oct. 2, 2014

(54) System and Method for Wireless Charging Control

(71) Applicant: Maxwave Co., Ltd., Daejeon (KR)

(72) Inventor: Dong Sik Ahn, Daejeon (KR)

(73) Assignee: Maxwave Co., Ltd., Daejeon (KR)

(21) Appl. No.: 14/224,684

(22) Filed: Mar. 25, 2014

(30) Foreign Application Priority Data
Mar. 26, 2013 (KR) 10-2013-0031882

(51) Int. Cl. H02J 7/02

(52) U.S. Cl. CPC H02J 7/025; H02J 2007/0096
USPC 320/108; 320/137

(57) ABSTRACT

Provided are a system and a method for wireless charging control, and more particularly, to a system and a method for wireless charging control capable of safely and conveniently performing wireless charging of a battery unit by performing near field communication and wireless charging between a power transmitting unit and a receiving charging unit in a time division manner using a common antenna which may be used for both of the near field communication and the wireless charging.

### TECHNICAL FIELD

The present invention relates to a system and a method for wireless charging control, and more particularly, to a system and a method for wireless charging control capable of safely and conveniently performing wireless charging of a battery unit by performing near field communication and wireless charging between a power transmitting unit and a receiving charging unit in a time division manner using a common antenna which may be used for both of the near field communication and the wireless charging.

### BACKGROUND

Generally, a battery pack is coupled with various types of portable terminals, such as a mobile telephone, personal digital assistants (PDAs), an MP3 player, digital multimedia broadcasting (DMB), a portable music player (PMP), and the like, so as to supply power to the portable terminals.

A user of the portable terminals charges a battery pack using a charger when a voltage of the battery pack drops to a predetermined level or less and then uses the portable terminals again, and most of the battery packs have connection terminals exposed to the outside so as to be electrically connected to charging terminals which are equipped in the charger and the user performs charging in the state in which the charging terminals of the charger contact the connection terminals of the battery pack to keep an electrical connection state therebetween.

However, since the charging terminal of the charger and the connection terminal of the battery pack are always exposed to the outside, the charging terminal and the connection terminal may be easily polluted by foreign materials and worn while the charger and the battery pack contacts or is separated from each other, and in the humid atmosphere, the charging terminal or the connection terminal may be corroded to make the connection between the connection terminal and the battery pack poor and in the case of the moisture permeation into the battery pack, the lifespan and performance of the battery pack may be reduced.

For this reason, recently, a contactless type charger which charges power in portable devices in a contactless manner has been developed and used.

A charger according to the related art requires a connector for transmitting an electrical signal between the charger and the battery pack, but the contactless type charger means a product which does not have contacts between the contactless type charger and the battery pack. Therefore, the contactless type charger wirelessly transmits the electrical signal between the contactless type charger and the battery pack through a coil and therefore a user puts the battery pack on the contactless type charger to perform charging.

That is, the contactless type charger means wirelessly charging the battery pack and the wireless charging type is largely divided into two. One of the wireless charging types is a magnetic induction type and the other of the wireless charging types is a magnetic resonance type.

The magnetic induction type means a type in which a magnetic field flows in a primary coil of a magnetic field radiation coil pad equipped in the contactless type charger to generate a magnetic field and thus an induction current flows in a secondary coil of the battery pack just on the contactless type charger to perform charging. The magnetic induction type may provide wireless charging within a range of several mm to several cm.

Further, the magnetic resonance type means a type which a resonance coil is mounted in the contactless type charger and the battery pack to transmit energy to an apparatus when a resonance frequency of the contactless charger coincides with that of the battery pack and absorb energy as an electromagnetic field when the resonance frequency of the contactless charger does not coincide with that of the battery pack. The magnetic resonance type may provide wireless charging within a range of several m.

However, according to the wireless charging type, the battery pack or the contactless type charger do not have a means which may detect foreign materials between the contactless type charger and the battery pack or abnormal high heat of the battery pack, and therefore the battery pack or the contactless type charger may be damaged due to these abnormal phenomena. Further, the battery pack may be damaged due to overcharging of the battery pack in response to overvoltage.

In addition, Korean Patent No. 10-0971717 (Wireless Type Charging And Data Communication Control Module For Mobile Terminal and Layout Of The Same) discloses a wireless type charging and data communication control module For mobile terminal and a layout of the same in which a power receiving coil of a charging system and a loop antenna of an electronic approval system are equipped in a battery pack and a cover case of a portable terminal to enable one portable terminal to perform the contactless charging and the electronic approval.

However, according to Korean Patent No. 10-0971717, since the power receiving coil for contactless charging and the loop antenna for the electronic approval system are equipped in one portable terminal, a thickness of the portable terminal is larger and an area of the portable terminal is increased, and therefore a user is inconvenient to carry the portable terminal in spite of the portable terminal.

In addition, the existing wireless charging chip developed from Texas Instruments (TI) Co., which is based on a method for transmitting a state of charge (SOC) information of the battery pack, changes an impedance of a receiver to change a current flow of a transmitting output terminal of a wireless transmitting pad which is a contactless type charger and senses the change current flow to change a communication signal, but the existing wireless charging chip is only unidirectional communication to transmit information on a receiving terminal to a transmitting terminal and may be implemented only in the TI chip and may be used only in an induction type from 110 KHz to 250 KHz, and therefore is inconvenient to apply to various structures, various frequencies, various charging types, and the like.

### RELATED ART DOCUMENT

### Patent Document

(Patent Document 1) Korean Patent No. 10-0971717 (Registration Date: Jul. 15, 2010)

### SUMMARY

An exemplary embodiment of the present invention is directed to providing a system and a method for wireless charging control performing near field communication and wireless charging between a power transmitting unit and a receiving charging unit in a time division manner using a common antenna which may be used for both of the near field communication and the wireless charging to control a supply amount of charging power supplied for contactless charging in response to current charging state information of a battery unit transmitted from the receiving charging unit in real time, thereby preventing power from unnecessarily wasting and protecting the battery unit from overcharging.

In one general aspect, there is provided a system for wireless charging control, including: a power transmitting unit 100 configured to include a power supply unit 110 supplying charging power for contactless charging using a commercial power supply, a DC/RF conversion unit 120 controlling a supply amount of the charging power and converting the controlled charging power into a wireless signal, and a first common antenna unit 130 transmitting the wireless signal converted by the DC/RF conversion unit 120; and a receiving charging unit 200 configured to include a second common antenna unit 210 receiving the wireless signal from the first common antenna unit 130, an RF/DC conversion unit 220 converting the wireless signal received by the second common antenna unit 210 into the charging power for contactless charging, and a battery unit 230 performing the contactless charging using the charging power transmitted from the RF/DC conversion unit 220. The power transmitting unit 100 may further include a sensor unit 140 configured of at least one sensor determining whether the power transmitting unit 100 contacts the receiving charging unit 200.

The power transmitting unit 100 may transmit a unique ID code of the power transmitting unit 100 to the receiving charging unit 200 through the first common antenna unit 130 if it is determined by the determination of the sensor unit 140 that the power transmitting unit 100 contacts the receiving charging unit 200.

The receiving charging unit 200 may further include a modulation unit 240 converting a receiving ID code of the receiving charging unit 200 and the current state of charge information of the battery unit 230 into an RF signal and transmit the RF signal to the power transmitting unit 200 when the unique ID code is received from the power transmitting unit 100. The power transmitting unit 100 may further include a demodulation unit 150 converting the RF signal received from the receiving charging unit 200 into the receiving ID code and the current state of charge information.

The power transmitting unit 100 may be configured to further include a first control unit 160 determining the receiving ID code of the receiving charging unit 200 and the current state of charge information which are converted by the demodulation unit 150, and control the supply amount of charging power transmitted to the receiving charging unit 200 depending on the determination of the first control unit 160.

The DC/RF conversion unit 120 may control a power transmitting time width or controls an impedance for a predetermined time depending on a required current amount when the current state of charge information of the battery unit 230 is in a constant voltage and current falling state by using the current state of charge information to control the supply amount of charging power.

In another general aspect, there is provided a method for wireless charging control, including: determining whether a power transmitting unit contacts a receiving charging unit using at least one sensor (S100); as the determination result of the determining of the contact (S100), if it is determined that the power transmitting unit contacts the receiving charging unit, transmitting a unique ID code of the power transmitting unit to the receiving charging unit (S200); transmitting a receiving ID code of the receiving charging unit and a current state of charge information of the battery unit, which are converted into an RF signal depending on the unique ID code received from the power transmitting unit, from the receiving charging unit to the power transmitting unit (S300); performing a control, by a first control unit of the power transmitting unit, to determine the RF signal (S400); and performing contactless charging by controlling a supply amount of charging power supplied from the power transmitting unit to the receiving charging unit depending on the current state of charge information of the RF signal in the controlling (S400) (S500). After the performing of the wireless charging (S500) is performed for a predetermined time, the transmitting of the ID code (S200), the transmitting of the corresponding information (S300), the performing of the control (S400), and the performing of the contactless charging (S500) may be repeatedly performed.

In the performing of the contactless charging (S500), when the current state of charge information of the battery unit is in a constant voltage and current falling state, a power transmitting time width may be controlled or an impedance may be controlled for a predetermined time depending on a required current amount to control the supply amount of charging power.

### BRIEF DESCRIPTION OF THE DRAWINGS

FIG. 1 is a diagram schematically illustrating a system for wireless charging control according to an exemplary embodiment of the present invention.

FIG. 2 is a flow chart illustrating a method for wireless charging control according to an exemplary embodiment of the present invention.

FIG. 3 is a diagram illustrating a signal waveform in a power transmitting unit 100 according to an exemplary embodiment of the present invention.

FIG. 4 is a diagram illustrating a signal waveform in the power transmitting unit 100 using the method for wireless charging control according to the exemplary embodiment of the present invention.

FIG. 5 is a diagram illustrating a signal waveform in a receiving charging unit 200 using the method for wireless charging control according to the exemplary embodiment of the present invention.

FIG. 6 is a diagram illustrating a signal waveform in the power transmitting unit 100 and the receiving charging unit 200 which performs contactless charging according to an exemplary embodiment of the present invention.

FIG. 7 is a diagram illustrating a signal waveform in the power transmitting unit 100 and the receiving charging unit 200 which does not perform the contactless charging according to the exemplary embodiment of the present invention.

FIG. 8 is a diagram illustrating a voltage and a current of a battery unit 230 which is being charged in a contactless manner according to the system for wireless charging control according to the exemplary embodiment of the present invention.

FIG. 9 is another diagram illustrating a voltage and a current of the deep-discharged battery unit 230 which is being charged in a contactless manner according to the system for wireless charging control according to the exemplary embodiment of the present invention.

### DETAILED DESCRIPTION OF MAIN ELEMENTS

100: POWER TRANSMITTING UNIT
110: POWER SUPPLY UNIT
120: DC/RF CONVERSION UNIT
130: FIRST COMMON ANTENNA UNIT
140: SENSOR UNIT
150: DEMODULATION UNIT
160: FIRST CONTROL UNIT
200: RECEIVING CHARGING UNIT
210: SECOND COMMON ANTENNA UNIT
220: RF/DC CONVERSION UNIT
230: BATTERY UNIT
240: MODULATION UNIT
S100 TO S500: EACH STEP OF METHOD FOR WIRELESS CHARGING CONTROL ACCORDING TO PRESENT INVENTION

### DETAILED DESCRIPTION OF EMBODIMENTS

A system and a method for wireless charging control according to an exemplary embodiment of the present invention will be described in more detail with reference to the accompanying drawings. The drawings exemplified below are provided by way of examples so that the spirit of the present invention can be sufficiently transmitted to those skilled in the art to which the present invention pertains. Therefore, the prevent invention is not limited to the drawings set forth below, and may be embodied in different forms. Also, like reference numerals denote like elements throughout the specification.

Here, unless indicated otherwise, the terms used in the specification including technical and scientific terms have the same meaning as those that are usually understood by those who skilled in the art to which the present invention pertains, and detailed description of the known functions and constitutions that may obscure the gist of the present invention will be omitted.

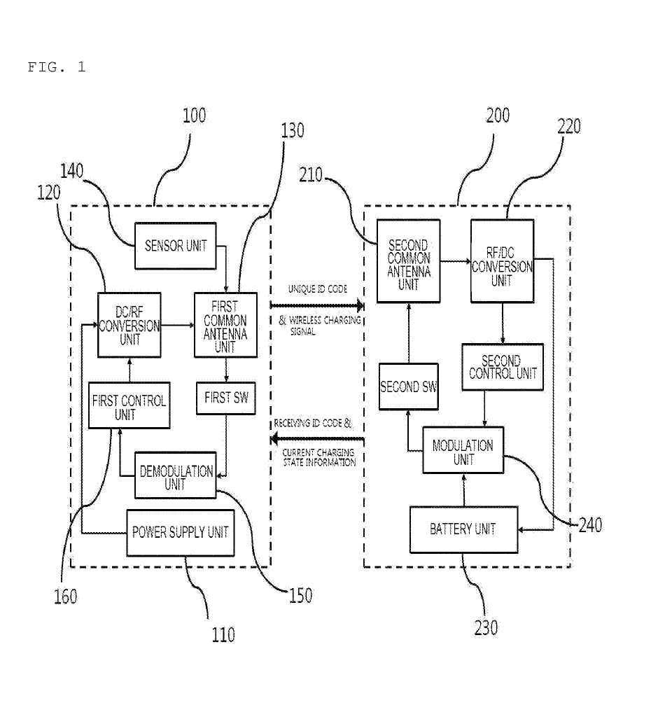

FIG. 1 is a diagram schematically illustrating a system for wireless charging control according to an exemplary embodiment of the present invention. A system for wireless charging control according to an exemplary embodiment of the present invention will be described in detail with reference to FIG. 1.

The system for wireless charging control according to the exemplary embodiment of the present invention may be configured to include a power transmitting unit 100 and a receiving charging unit 200.

As illustrated in FIG. 1, the power transmitting unit 100 is configured to include a power supply unit 110, a DC/RF conversion unit 120, a first common antenna unit 130, a sensor unit 140, a demodulation unit 150, a first control unit 160, and first SW and the receiving charging unit 200 is configured to include a second common antenna unit 210, an RF/DC conversion unit 220, a battery unit 230, a modulation unit 240, a second control unit, and a second SW.

The power transmitting unit 100 and the receiving charging unit 200 may simultaneously transmit and receive near field communication (NFC) and a contactless charging signal through the first common antenna unit 130 and the second common antenna unit 210.

Generally, the near field communication and the contactless charging signal may use the same frequency, that is, 13.5 MHz, and the system for wireless charging control according to the exemplary embodiment of the present invention use the near field communication signal and the wireless charging signal for contactless charging the same frequency to stop the contactless charging for a predetermined time in a time division manner and receives a current state of charge information for the predetermined time to control a supply amount of charging power in real time depending on the current state of charge information, thereby performing the contactless charging.

In more detail, the power supply unit 110 of the power transmitting unit 100 uses a commercial power supply to supply charging power for contactless charging. In other words, the power supply unit 110 supplies operation power required for power generation for contactless charging using the commercial power supply and the system for wireless charging control according to the exemplary embodiment of the present invention simply transmits the charging power supplied from the power supply unit 110 to the battery unit 230 of the receiving charging unit 200 in a contactless manner to perform the charging.

The DC/RF conversion unit 120 may convert the charging power supplied from the power supply unit 110 into a radio frequency (RF) signal which is a wireless signal (hereinafter, wireless charging signal) for contactless charging. In this case, the DC/RF conversion unit 120 may control a power transmitting time width or an impedance to control the supply amount of charging power and thus may control the wireless charging signal supplied to the battery unit 230 of the receiving charging unit 200, that is, to control the supply amount of charging power.

As described above, the power transmitting unit 100 may transmit the wireless charging signal converted by the DC/RF conversion unit 120 to the receiving charging unit 200 through the first common antenna unit 130 to perform the contactless charging and may use the near field communication or the demodulation unit 150 to receive a receiving ID code of the receiving charging unit 200 and the RF signal obtained by converting the current state of charge information of the battery unit 230.

The second common antenna unit 210 of the receiving charging unit 200 receives the wireless charging signal from the first common antenna unit 130 of the power transmitting unit 100 to perform the contactless charging and as described above, uses the near field communication or the modulation unit 240 to transmit the receiving ID code of the receiving charging unit 200 and the RF signal obtained by converting the current state of charge information of the battery unit 230 to the power transmitting unit 100.

That is, the first common antenna unit 130 of the power transmitting unit 100 and the second common antenna unit 210 of the receiving charging unit 200 may be configured of a common antenna which may be used in both of the wireless charging signal and the near field communication.

The RF/DC conversion unit 220 converts the wireless charging signal received to the second common antenna unit 210 into the charging power for contactless charging to control the contactless charging.

The battery unit 230 performs the contactless charging using the charging power which is converted and transmitted by the RF/DC conversion unit 220 and therefore the system for wireless charging control according to the exemplary embodiment of the present invention transmits the charging power supplied from the power supply unit 110 of the power transmitting unit 100 to the battery unit 230 of the receiving charging unit 200 to perform the contactless charging.

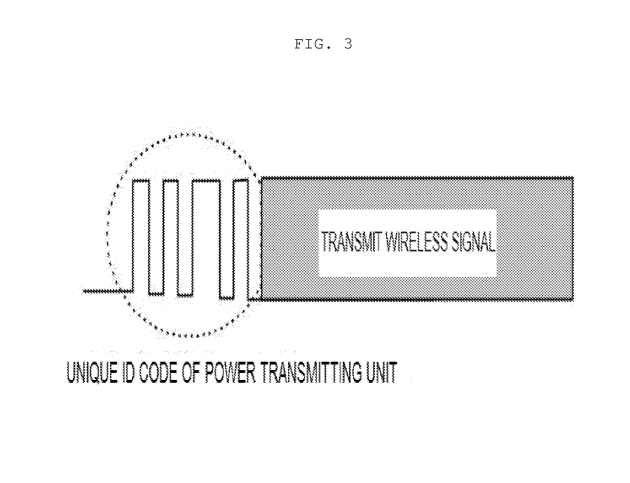

In this case, the power transmitting unit 100 may use at least one sensor configuring the sensor unit 140 to determine whether the power transmitting unit 100 contacts the receiving charging unit 200 and if it is confirmed that the power transmitting unit 100 simply contacts the receiving charging unit 200, does not perform the contactless charging unconditionally; however, if it is confirmed by the determination of the sensor unit 140 that the power transmitting unit 100 contacts the receiving charging unit 200, as illustrated in FIG. 3, the power transmitting unit 100 transmits a unique ID code of the power transmitting unit 100 to the receiving charging unit 200 through the first common antenna unit 130.

When the receiving charging unit 200 receives the unique ID code of the power transmitting unit 100, the receiving charging unit 200 transmits the RF signal, that is, the receiving ID code and the RF signal obtained by converting the current state of charge information of the battery unit 230 to the power transmitting unit 100.

When the receiving charging unit 200 receives the unique ID code from the power transmitting unit 100, the receiving charging unit 200 transmits the RF signal, that is, the receiving ID code of the receiving charging unit 200 and the RF signal obtained by converting the current state of charge information of the battery unit 230 to the power transmitting unit 100 through the modulation unit 240.

In this case, the power transmitting unit 100 may be configured to further include the first control unit 160, in which the first control unit 160 determines the RF signal to control the power transmitting unit 100.

In more detail, the unique ID code transmitted from the power transmitting unit 100 to the receiving charging unit 200 informs the starting of the contactless charging or indicates a specific wireless signal and the receiving ID code in the RF signal transmitted from the receiving charging unit 200 to the power transmitting unit 100 corresponding to the unique ID code indicates that a preparation for contactless charging corresponding to the unique ID code is completed.

Further, the power transmitting unit 100 performs the charging of the receiving charging unit 200 based on the current state of charge information of the battery unit 230 in the RF signal.

That is, the first control unit 160 determines the current state of charge information of the battery unit 230 in the RF signal to control the supply amount of charging power transmitted to the receiving charging unit 200.

In this case, the power transmitting unit 100 may further include the demodulation unit 150 to convert the RF signal received from the receiving charging unit 200. Therefore, the power transmitting unit 100 may control the supply amount of charging power converted by the DC/RF conversion unit 120 depending on the current state of charge information of the battery unit 230 to control the supply amount of charging power transmitted to the battery unit 230 of the receiving charging unit 200.

In this case, the power transmitting unit 100 may control the supply amount of charging power supplied in real time depending on the current state of charge information of the battery unit 230 to prevent the battery unit 100 from overcharging.

Further, when the current state of charge information of the battery unit 230 is in a full charge state and thus the charging is no more required, that is, after the power transmitting unit 100 transmits the unique ID code, when the current state of charge information of the RF signal received from the receiving charging unit 200 is in a full charge state, the system for wireless charging control according to the exemplary embodiment of the present invention does not transmit the wireless charging signal and transmits an ending signal after the predetermined time (generally, time to transmit the wireless charging signal) elapses. This means that one-time contactless charging ends, and the system for wireless charging control transmits the unique ID code once more and receives the RF signal updated in real time to check the state of charge of the battery unit 230, thereby controlling the supply amount of charging power.

In addition, when the receiving ID code of the receiving charging unit 200 corresponding to the unique ID code of the power transmitting unit 100 is not a signal for contactless charging or the contactless charging is not prepared, the system for wireless charging control according to the exemplary embodiment of the present invention repeats a process of transmitting the unique ID code to the receiving charging unit 200 and receiving the RF signal of the receiving charging unit 200 predetermined times depending on the determination of the first control unit 160. Next, when the RF signal from the receiving charging unit 200 is not present or when the receiving ID code of the receiving charging unit 200 is not prepared for the contactless charging, the system for wireless charging control may display a warning without transmitting the wireless charging signal.

In this case, the predetermined number of times is set to be three times, but this is only the exemplary embodiment of the present invention and may be changed depending on the setting of the power transmitting unit 100 and the receiving charging unit 200, and the warning display may be informed to the power transmitting unit 100 or the receiving charging unit 200 as a message or may be performed using a separate LED lamp.

Further, when the battery unit 230 is in the deep-discharge state in which the battery unit 230 is necessarily charged, the system for wireless charging control according to the exemplary embodiment of the present invention may receive the unique ID code from the power transmitting unit 100 but may not transmit the RF signal therefor. To the contrary, the power transmitting unit 100 simply transmits the wireless charging signal having an appropriate strength for a predetermined time.

In other words, the contact between the power transmitting unit 100 and the receiving charging unit 200 is confirmed by the sensor unit 140 of the power transmitting unit 100 and thus the unique ID code is transmitted from the power transmitting unit 100 to the receiving charging unit 200, but when the receiving charging unit 200 is deep-discharged, since the RF signal corresponding thereto may not be transmitted and received at all, the contact between the power transmitting unit 100 and the receiving charging unit 200 is confirmed using the sensor unit 140, but the deep-discharge of the receiving charging unit 200 which may not performed later is determined and thus the wireless charging signal having an appropriate strength at which the receiving charging unit 200 may be minimally charged is transmitted for the predetermined time and then the contactless charging may be performed through the receiving charging unit 200.

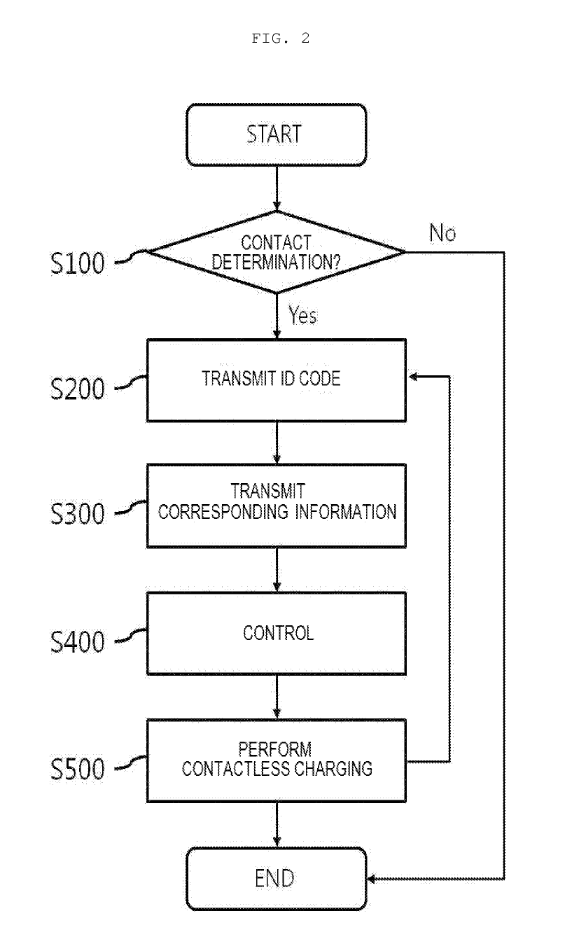

FIG. 2 is a flow chart illustrating a method for wireless charging control according to an exemplary embodiment of the present invention. A method for wireless charging control according to an exemplary embodiment of the present invention will be described in detail with reference to FIG. 2.

The method for wireless charging control according to the exemplary embodiment of the present invention may include determining a contact (S100), transmitting an ID code (S200), transmitting corresponding information (S300), controlling (S400), and performing contactless charging (S500).

The determining of the contact (S100) may determine whether the power transmitting unit 100 contacts the receiving charging unit 200 based on the sensor unit 140 of the power transmitting unit 100 configured of at least one sensor.

By this configuration, if it is confirmed that the power transmitting unit 100 contacts the receiving charging unit 200, the charging power for contactless charging supplied from the power supply unit 110 of the power transmitting unit 100 may be transmitted to the battery unit 230 of the receiving charging unit 200 to perform the contactless charging.

In the transmitting of the ID code (S200), depending on the determination result of the determining of the contact (S100), the unique ID code of the power transmitting unit 100 may be transmitted to the receiving charging unit 200 through the first common antenna unit 130 of the power transmitting unit 100 to prevent the battery unit 230 from overcharging due to the unconditional contactless charging when the power transmitting unit 100 contacts the receiving charging unit 200.

In the transmitting of the corresponding information (S300), the RF signal corresponding to the unique ID code received from the power transmitting unit 100, that is, the receiving ID code of the receiving charging unit 200 and the RF signal obtained by converting the current state of charge information of the battery unit 230 may be transmitted from the receiving charging unit 200 to the power transmitting unit 100.

In the controlling (S400), the first control unit 160 of the power transmitting unit 100 may determine the RF signal to control the power transmitting unit 100.

As described above, the unique ID code transferred from the power transmitting unit 100 to the receiving charging unit 200 informs the starting of the contactless charging or indicates a specific wireless signal and the receiving ID code in the RF signal transmitted from the receiving charging unit 200 to the power transmitting unit 100 corresponding to the unique ID code indicates that a preparation for contactless charging corresponding to the unique ID code is completed.

Further, the power transmitting unit 100 performs the charging of the receiving charging unit 200 based on the current state of charge information of the battery unit 230 in the RF signal.

That is, the first control unit 160 determines the current state of charge information of the battery unit 230 in the RF signal to control the supply amount of charging power transmitted to the receiving charging unit 200.

In this case, the power transmitting unit 100 may further include the demodulation unit 150 to convert the RF signal received from the receiving charging unit 200. Therefore, the power transmitting unit 100 may control the supply amount of charging power converted by the DC/RF conversion unit 120 depending on the current state of charge information of the battery unit 230 to control the supply amount of charging power transmitted to the battery unit 230 of the receiving charging unit 200.

In this case, the power transmitting unit 100 may control the supply amount of charging power supplied in real time depending on the current state of charge information of the battery unit 230 to prevent the battery unit 230 from overcharging.

In this case, when the receiving ID code of the receiving charging unit 200 corresponding to the unique ID code of the power transmitting unit 100 is not a signal for contactless charging or the contactless charging is not prepared, the method for wireless charging control according to the exemplary embodiment of the present invention repeats a process of transmitting the unique ID code to the receiving charging unit 200 and receiving the RF signal of the receiving charging unit 200 predetermined times depending on the determination of the first control unit 160 in the controlling (S400). Next, when the RF signal from the receiving charging unit 200 is not present or when the receiving ID code of the receiving charging unit 200 is not prepared from the contactless charging, the method for wireless charging control may display a warning without transmitting the wireless charging signal.

In this case, the predetermined times is set to be three times, but this is only the exemplary embodiment of the present invention and may be changed depending on the setting of the power transmitting unit 100 and the receiving charging unit 200, and the warning display may be informed to the power transmitting unit 100 or the receiving charging unit 200 as a message or may be performed using a separate LED lamp.

In the performing of the contactless charging (S500), the supply amount of charging power for contactless charging supplied from the power transmitting unit 100 to the receiving charging unit 200 depending on the current state of charge information of the battery unit 230 included in the RF signal in the controlling (S400) is controlled to smoothly perform the contactless charging.

In this case, the DC/RF conversion unit 120 may control a power transmitting time width or an impedance to control the supply amount of charging power and thus may control the contactless charging signal supplied to the battery unit 230 of the receiving charging unit 200, that is, the contactless charging to control the supply amount of charging power.

The method for wireless charging control according to the exemplary embodiment of the present invention may repeatedly perform the transmitting of the ID code (S200), the transmitting of the corresponding information (S300), the controlling (S400), and the performing of the contactless charging (S500), after the performing of the wireless charging (S500) for a predetermined time.

In this way, the current state of charge information of the battery unit 230 may be checked in real time to control the supply amount of charging power supplied from the power transmitting unit 100 to the receiving charging unit 200 depending on the current state of charge information of the battery unit 230.

That is, when the current state of charge information of the battery unit 230 is in a constant voltage and current falling state, the method for wireless charging control according to the exemplary embodiment of the present invention controls the power transmitting time width or the impedance for a predetermined time to control the supply amount of charging power, but after the power transmitting unit 100 transmits the unique ID code, when the current state of charge information of the battery unit 230 is in a full charge state and thus the charging is no more required, the method for wireless charging control according to the exemplary embodiment of the present invention does not transmit the wireless charging signal and transmits the ending signal after the predetermined time (generally, time to transmit the wireless charging signal) elapses. This means that one-time contactless charging ends, and the system for wireless charging control transmits the unique ID code once more and receives the RF signal updated in real time to check the state of charge of the battery unit 230, thereby controlling the supply amount of charging power.

FIG. 3 is a diagram illustrating a signal waveform obtained when the power transmitting unit 100 transmits the unique ID code and the wireless charging signal.

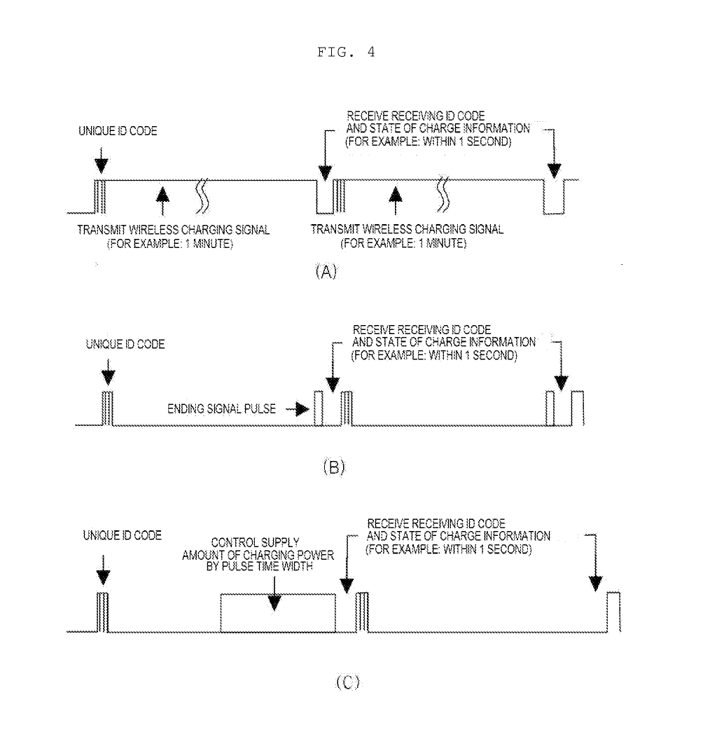

FIG. 4A is a diagram illustrating the signal waveform in the power transmitting unit 100 when the contactless charging is performed and FIG. 4B is a diagram illustrating the signal waveform in the power transmitting unit 100 when the contactless charging is not performed.

FIG. 4C is a diagram illustrating the signal waveform of the supply amount of charging power which is controlled depending on the current state of charge information of the battery unit 230 received from the receiving charging unit 200.

In more detail, FIG. 4A illustrates that the power transmitting unit 100 transmits the unique ID code and then transmits the wireless charging signal. Next, the signal waveform does not appear while the receiving charging unit 200 receives the current state of charge information of the battery unit 230.

Depending on the current state of charge information of the battery unit 230, if it is determined that the contactless charging is required, the method for wireless charging control is performed.

In FIG. 4B, when the power transmitting unit 100 transmits the unique ID code, but the RF signal is not received from the receiving charging unit 200, the RF signal is not a signal for contactless charging, the current state of charge information of the battery unit 230 is in a full charge state depending on the received RF signal, the ending signal is transmitted. In this way, this means that the one-time contactless charging ends, and the unique ID code is transmitted once more and the current state of charge information is received to check the charging state of the battery unit 230 in real time, thereby controlling the supply amount of charging power.

In FIG. 4C, after the power transmitting unit 100 transmits the unique ID code, the RF signal is received from the receiving charging unit 200 and the supply amount of charging power supplied from the power transmitting unit 100 to the receiving charging unit 200 is controlled depending on the current state of charge information of the battery unit 230.

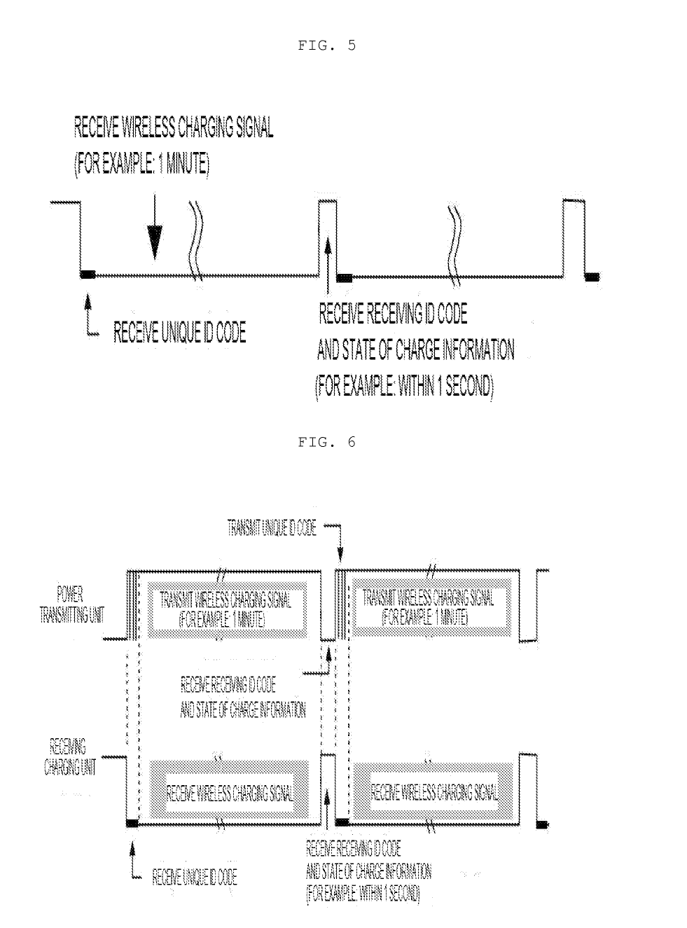

FIG. 5 is a diagram the signal waveform in the receiving charging unit 200 and the receiving charging unit 200 receives the unique ID code and the wireless charging signal from the power transmitting unit 100 and transmits the receiving ID code and the RF signal obtained by converting the current state of charge information of the battery unit 230.

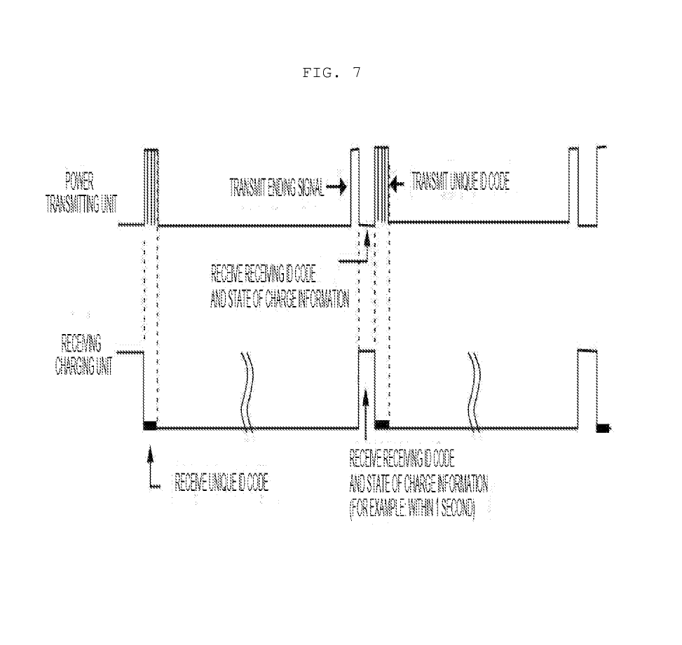

FIG. 6 is a diagram illustrating the signal waveforms in the power transmitting unit 100 and the receiving charging unit 200 which perform the contactless charging.

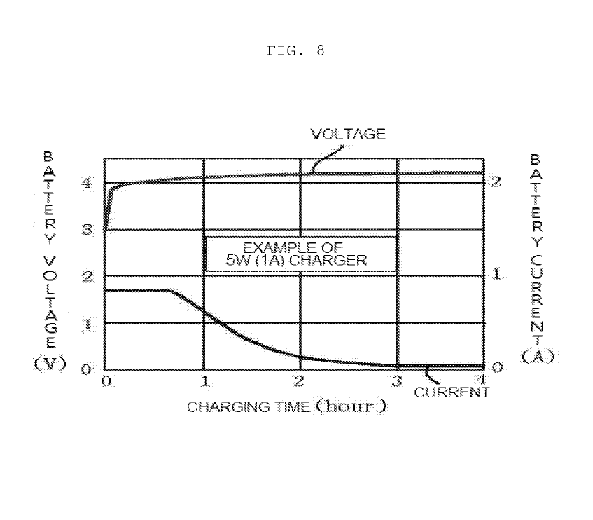

FIG. 7 is a diagram illustrating the signal waveforms in the power transmitting unit 100 and the receiving charging unit 200 which does not perform the contactless charging.

As illustrated in FIGS. 6 and 7, the near field communication for transmitting the wireless charging signal for contactless charging and the current state of charge information of the battery unit 230 are performed using the first common antenna unit 130 and the second common antenna unit 210, the near far wireless communication temporarily stops while the wireless charging signal is transmitted and received in a time division manner, and when the wireless charging signal ends as the ending signal, the RF signal, that is, the receiving ID of the receiving charging unit 200 and the current state of charge information of the battery unit 230 are transmitted through the near field communication. In this way, it is possible to prevent the unnecessary power waste and prevent the battery unit 230 from overcharging.

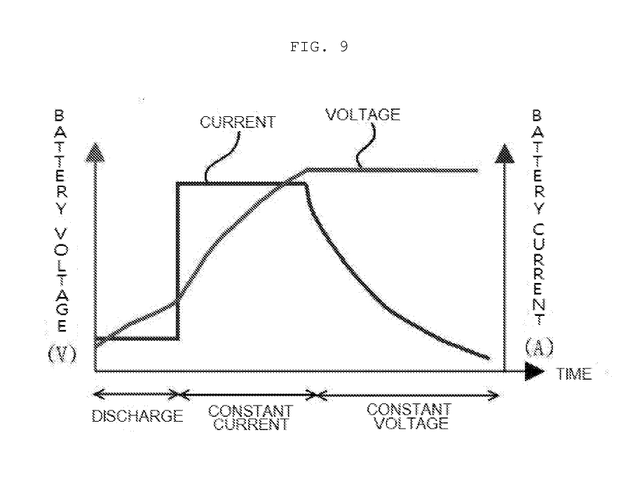

FIG. 8 is a diagram illustrating a voltage and a current of the battery unit 230 during the contactless charging.

FIG. 9 is another diagram illustrating the voltage and the current of the battery unit 230 during the contactless charging.

In this case, as illustrated in FIG. 9, when the battery unit 230 is deep-discharged, since the RF signal may not be transmitted from the power charging unit 100 through the receiving charging unit 200, the power transmitting unit 100 determines that the receiving charging unit 200 is deep-discharged to transmit the wireless charging signal having an appropriate strength at which the receiving charging unit 200 may be minimally charged for the predetermined time and perform the contactless charging through the receiving charging unit 200 which is charged later.

According to the system and the method for wireless charging control having the above configuration, the near field communication and the wireless charging between the power transmitting unit and the receiving charging unit are performed in a time division manner using the common antenna which may be used for both of the near field communication and the wireless charging to control the supply amount of charging power supplied for contactless charging in response to the current charging state information of the battery unit transmitted from the receiving charging unit in real time, thereby preventing power from unnecessarily wasting and protecting the battery unit from overcharging.

Further, the power transmitting unit accurately recognizes the state of charge of the receiving charging unit and then determines and controls whether the charging power is transmitted, thereby preventing the malfunction of wireless charging and safely performing the wireless charging.

In addition, when the wireless charging frequency coincides with the near field communication (NFC) frequency, the component for modulating or demodulating a signal in the power transmitting unit and the receiving charging unit commonly uses the near field communication and the wireless charging using the near field communication system, thereby simplifying the system.

As described above, the present invention is described with reference to specific matters such as the detailed components and the limited exemplary embodiments, but is provided to help a general understanding of the present invention. Therefore, the present invention is not limited to the above exemplary embodiments and can be variously changed and modified from the description by a person skilled in the art to which the present invention pertain.

Therefore, the spirit of the present invention should not be limited to the above-described exemplary embodiments, and the following claims as well as all modified equally or equivalently to the claims are intended to fall within the scope and spirit of the invention.

What is claimed is:

1. A system for wireless charging control, comprising:
a power transmitting unit configured to include a power supply unit supplying charging power for contactless charging using a commercial power supply, a DC/RF conversion unit controlling a supply amount of the charging power and converting the controlled charging power into a wireless signal, and a first common antenna unit transmitting the wireless signal converted by the DC/RF conversion unit; and
a receiving charging unit configured to include a second common antenna unit receiving the wireless signal from the first common antenna unit, an RF/DC conversion unit converting the wireless signal received by the second common antenna unit into the charging power for contactless charging, and a battery unit performing the contactless charging using the charging power transmitted from the RF/DC conversion unit.

2. The system of claim 1, wherein the power transmitting unit further includes a sensor unit configured of at least one sensor determining whether the power transmitting unit contacts the receiving charging unit.

3. The system of claim 2, wherein the power transmitting unit transmits a unique ID code of the power transmitting unit to the receiving charging unit through the first common antenna unit if it is determined by the determination of the sensor unit that the power transmitting unit contacts the receiving charging unit.

4. The system of claim 3, wherein the receiving charging unit further includes a modulation unit converting a receiving ID code of the receiving charging unit and the current state of charge information of the battery unit into an RF signal and transmits the RF signal to the power transmitting unit when the unique ID code is received from the power transmitting unit.

5. The system of claim 4, wherein the power transmitting unit further includes a demodulation unit converting the RF signal received from the receiving charging unit into the receiving ID code and the current state of charge information.

6. The system of claim 5, wherein the power transmitting unit further includes a first control unit determining the receiving ID code of the receiving charging unit and the current state of charge information which are converted by the demodulation unit and controls the supply amount of charging power transmitted to the receiving charging unit depending on the determination of the first control unit.

7. The system of claim 1, wherein the DC/RF conversion unit controls a power transmitting time width or controls an impedance for a predetermined time depending on a required current amount when the current state of charge information of the battery unit is in a constant voltage and current falling state by using the current state of charge information to control the supply amount of charging power.

8. A method for wireless charging control, comprising:
determining whether a power transmitting unit contacts a receiving charging unit using at least one sensor;
as the determination result of the determining of the contact, if it is determined that the power transmitting unit contacts the receiving charging unit, transmitting a unique ID code of the power transmitting unit to the receiving charging unit;
transmitting a receiving ID code of the receiving charging unit and a current state of charge information of the battery unit, which are converted into an RF signal depending on the unique ID code received from the power transmitting unit, from the receiving charging unit to the power transmitting unit;
performing a control, by a first control unit of the power transmitting unit, to determine the RF signal; and
performing contactless charging by controlling a supply amount of charging power supplied from the power transmitting unit to the receiving charging unit depending on the current state of charge information of the RF signal in the controlling.

9. The method of claim 8, wherein after the performing of the wireless charging is performed for a predetermined time, the transmitting of the ID code, the transmitting of the corresponding information, the performing of the control, and the performing of the contactless charging are repeatedly performed.

10. The method of claim 8, wherein in the performing of the contactless charging, when the current state of charge information of the battery unit is in a constant voltage and current falling state, a power transmitting time width is controlled or an impedance is controlled for a predetermined time depending on a required current amount to control the supply amount of charging power.
